(19) United States
(12) Patent Application Publication
(10) Pub. No.: US 2022/0391988 A1
(43) Pub. Date: Dec. 8, 2022

(54) SYSTEM AND METHOD FOR PROVIDING AUTOMATIC RATING AND ELECTRONIC TRADING OF INSURANCE RISKS

(71) Applicant: Nikhil Govind SOMAN, Thane West, Thane (IN)

(72) Inventor: Nikhil Govind SOMAN, Thane West, Thane (IN)

(21) Appl. No.: 17/606,405

(22) PCT Filed: Mar. 27, 2020
(86) PCT No.: PCT/IN2020/050286

§ 371 Date: Oct. 25, 2021

(30) Foreign Application Priority Data
Apr. 29, 2019 (IN) 201921017011

(51) Int. Cl. G06Q 40/08

(52) U.S. Cl. CPC G06Q 40/08

(57) ABSTRACT

Disclosed are a system (100) and a method for providing an automatic rating and electronic trading of insurance risks. The system (100) comprises a database (10), a middleware, a user interface (20), a submission workspace (30), an application interface (40) and a trading interface (50). The system (100) and the method facilitate the standardization of the insurance information resulting in simplification of processes and output to the clients. The system (100) and the method facilitate automation of premium computation leading to robust decision support system for underwriters. The system (100) and the method provide validated loss index that is useful as an underlying asset for insurance linked derivative securities.

### FIELD OF THE INVENTION

The present invention relates generally to a financial risk assessment and more particularly, to an internet-based system and a method for providing an automatic rating and electronic trading of insurance risks.

### BACKGROUND OF THE INVENTION

The processes and customs followed in an insurance market have not changed much since last 100 years. Emails and websites have replaced medium of communication but core insurance processes have remained manual. FIG. 1 illustrates a buying process of an existing insurance market. As shown in FIG. 1, there are exchange platforms but those platforms offer mere sharing of documents over a web-based application and provide a virtual co-working space. Further, the existing platforms have not improved or offered to simplify the operating procedures of the insurance companies.

Efforts are seen in the prior art to develop systems that provides financial risk assessment. Reference may be made to U.S. Pat. No. 10,178,111B1 that discloses aspects and examples for providing compressed risk assessment messages for real-time transmission to online services. For example, a request for a compressed risk assessment message about an entity is received from an online service. The compressed risk assessment message is generated by executing a risk assessment algorithm with at least some data about the entity. The compressed risk assessment message indicates a risk associated with the entity. The risk is indicated using less data than a detailed risk assessment generated by the risk assessment system, which may include an explanation indicating how the risk is determined. The compressed risk assessment message is transmitted to an online service that requests the compressed risk assessment. However, this patent does not generate a loss index through an accumulated risk data. Further, this patent does not provide dynamic risk assessment based on past pool of risks.

Another U.S. Pat. No. 5,704,045A discloses that a system and a method of accepting risk through contractual obligations transfers a portion of the risk to investors and includes means for absolute assurance of timely payment to contract holders, and segregation, of the interests of particular investors to specifically identified risks in a risk to capital matching system. The system creates separate ledgers and segregated reserves to tailor particular products for specific needs including transferring difficult to place risks. The system creates agreements which promise payments, based on loss from risks including investment risks. Data processing provides legally segregated relationship management links, supervising and balancing the interests of professionals in a risk transfer and diversification system. However, this patent does not generate a loss index through an accumulated risk data. Further, this patent does not provide dynamic risk assessment based on past pool of risks.

Korean patent application no. KR20150036212A discloses a method for estimating insurance risk. The method may include receiving, by a processor, real-time information related to a travel itinerary. The method may also include estimating, by the processor, the insurance risk by analyzing the real-time information based on a quantitative assessment of risks posed to a population by the at least one factor. The method may also include generating, by the processor, an insurance risk profile based on the estimated insurance risk. However, this patent does not generate a loss index through an accumulated risk data. Further, this patent does not provide dynamic risk assessment based on past pool of risks.

In addition, United States patent application no. US2015006206A1 and US2005108062A1 disclose system and method for evaluating an insurable risk. However, these patents do not generate a loss index through an accumulated risk data. Further, these patents do not provide dynamic risk assessment based on past pool of risks.

Accordingly, there exists a need to provide a system and a method for providing an automatic rating and electronic trading of insurance risks that overcomes the above mentioned drawbacks of the prior art.

### OBJECTS OF THE INVENTION

An object of the present invention is to provide a simplified method of insurance buying and claim reporting.

Another object of the present invention is to standardize and automate the routine underwriting processes thereby enabling insurance companies to carry out faster decision making.

Yet another object of the present invention is to provide a validated loss index to be used as underlying asset for insurance linked derivative securities.

### SUMMARY OF THE INVENTION

Accordingly, the present invention provides a system for providing an automatic rating and electronic trading of insurance risks. The system comprises a database, a middleware, a user interface, a submission workspace, an application interface and a trading interface.

The database is adapted to store data for all clients, brokers and insurance companies. The middleware is operably connected to the database. The middleware includes a premium computation algorithm/logic embedded therein. The premium computation algorithm is adapted to update a loss index with weight values for live insurance contract and to update the database of rejected offers for future reference.

The user interface is operably connected to the database. The user interface receives the data feed through a manual entry from the brokers. The submission workspace collates the data entered by the brokers, receives premium amounts and prepares an offer to be presented to the insurance companies. The application interface presents the offer with a suggested premium to the insurance companies. The trading interface is operably connected to the application interface for providing a decision support for the insurance companies and the application interface for presenting a trade to the buyer for a final decision.

In another aspect, the present invention provides a method for providing an automatic rating and electronic trading of insurance risks.

### BRIEF DESCRIPTION OF THE DRAWINGS

FIG. 1 shows a flowchart of a buying process of an existing insurance market, in accordance with the prior art;

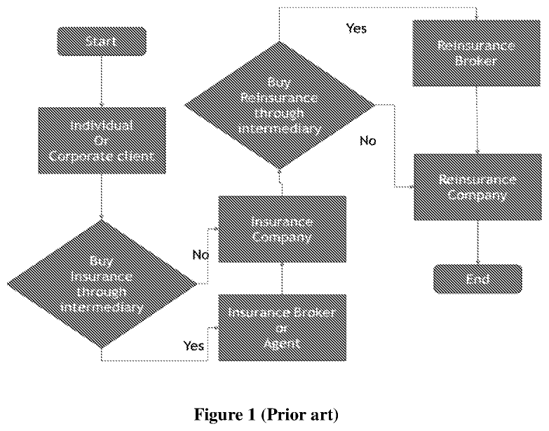

FIG. 2 shows a schematic of a system for providing an automatic rating and electronic trading of insurance risks, in accordance with the present invention;

FIG. 3 shows an insurance buying in the system of FIG. 1, in accordance with the present invention;

FIG. 4 is a block diagram depicting workflow of a premium computation algorithm/logic of the system of FIG. 1; and

FIG. 5 shows a flowchart of a method for providing an automatic rating and electronic trading of insurance risks, in accordance with the present invention.

### DETAILED DESCRIPTION OF THE INVENTION

The foregoing objects of the present invention are accomplished and the problems and shortcomings associated with the prior art, techniques and approaches are overcome by the present invention as described below in the preferred embodiments.

In general aspect, the present invention provides a system and a method for providing an automatic rating and electronic trading of insurance risks. Specifically, the system is an internet-based rating algorithm that facilitates electronic exchange of insurance risks. The rating algorithm provides a common platform to rate every possible insurance risk and has ability to adjust insurance premiums based on loss experience of an individual risk as well as the entire portfolio.

The present invention is illustrated with reference to the accompanying drawings, throughout which reference numbers indicate corresponding parts in the various figures. These reference numbers are shown in bracket in the following description.

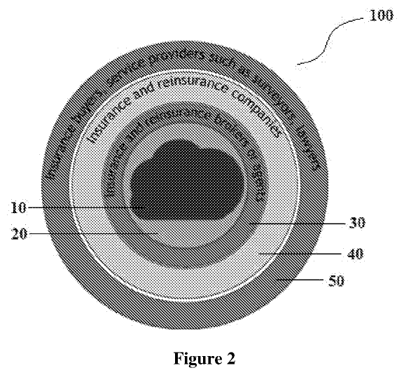

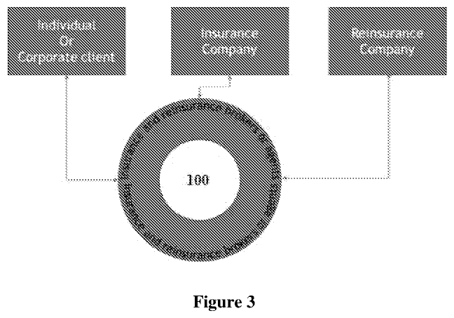

Referring to FIGS. 2-4, a system (100) for providing an automatic rating and electronic trading of insurance risks in accordance with the present invention is shown. The system (100) includes a database (10), a middleware (not shown), a user interface (20), a submission workspace (30), an application interface (40) and a trading interface (50).

The database (10) is adapted to store data for all the clients, brokers and insurance companies. The middleware is operably connected to the database (10). The middleware includes a premium computation algorithm/logic embedded therein. The premium computation algorithm is adapted to update a loss index with weight values for live insurance contract and to update the database (10) of rejected offers for future reference. In accordance with the present invention, the premium computation algorithm can be operated without a computer and can be used in manual records or in paper pencil system.

The user interface (20) is operably connected to the database (10). The user interface (20) receives the data feed through a manual entry from the brokers. The submission workspace (30) collates the data entered by the brokers, receives premium amounts, for example from Rs. 1, and prepares an offer to be presented to the insurance companies.

The application interface (40) is useful for insurance players and presents an offer with a suggested premium to the insurance companies. The trading interface (50) is operably connected to the application interface (40). The trading interface (50) provides a decision support for the insurance companies and the application interface (40) to present trade to the buyer for a final decision.

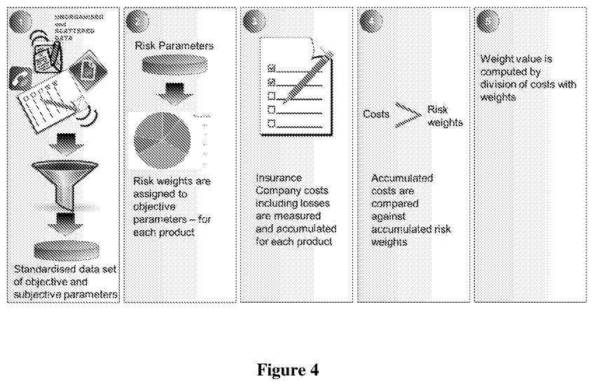

Now referring to FIG. 4, a block diagram depicting workflow of the premium computation algorithm/logic of the system (100) in accordance with the present invention is shown. The premium computation algorithm works in different phases. In phase 1, to apply the premium computation algorithm to a given set of information, application specific parameters such as risk parameters or key influencing variables are identified. The information is obtained in consultation with the buyer/client. In an embodiment, the parameters are classified in two categories namely objective parameters and subjective parameters. If sufficient sample data exists then correlation co-efficient for each objective parameter is computed wherein the correlation is to be checked with axis parameter such as limit of liability. For non-insurance evaluations, the correlation is checked with a face value of the stocks or other key parameters.

In phase 2, weights are assigned for each identified variable. Specifically, the standardized data set of the objective and subjective parameters are assigned with risk weights for the given product or client. In accordance with the present invention, higher co-relation is considered equal to higher weightage.

In phase 3, costs or intrinsic values that comprise costs to be recovered for computation of profit margin or recovery margin are identified. In accordance with the present invention, costs or intrinsic values are classified as static costs (fixed costs) and dynamic costs (variable costs). In the context of the present invention, the static values or fixed costs are the values that remain constant during an evaluation period and include, but are not limited to, management costs, treaty costs, loss cost for net retention portion and profit margin. The static values or fixed costs for stock or equity valuation include, but are not limited to, opportunity costs and liquidity costs or advantage. The liquidity cost is equal to penalty for early redemption. In accordance with the present invention, the opportunity cost is calculated by following equation:

Opportunity cost=Risk free rate of return×Investment amount−Tax payable

In the context of the present invention, dynamic values or variable costs are the values that change during evaluation period and include, but are not limited to, loss costs for the product or application. In accordance with the present invention, the loss cost is calculated by following equation:

Loss cost=Severity probability×Frequency probability×Product portfolio limit of liability

In the context of the present invention, dynamic costs of non insurance evaluations such as equity or stock valuation are loss costs for the product or application which would be objective parameters weight evaluation perception costs.

In accordance with the present invention, the objective parameters for equity valuation include, but are not limited to:
Accounting ratios such as net worth trend, profit margin trend, cash flow trend
Industry trend such as revenue trend of the industry peers
Political advantage or disadvantage to the industry as well as to the equity evaluated
Technology obsolescence or advantage to the insured as well as to the industry
Capital intensive or labor intensive nature of the equity as well as industry
Regulatory intervention for the equity as well as to the industry
Number of players in the competition or intensity of the competition

Hence, objective parameters for equity valuation would be—accounting ratios—net worth trend, profit margin trend, cash flow trend and the like.

After phase 3 is completed, the premium computation algorithm is ready to accept and process the client data. In phase 4, the premium computation algorithm compares costs against variables and computes the weight value. As the weight value is dynamic, every time one of the variable changes the weight value changes. In phase 5, the weight value is calculated by following equation:

Weight value=Sum of costs/Sum of weights×Weight value adjustment factor

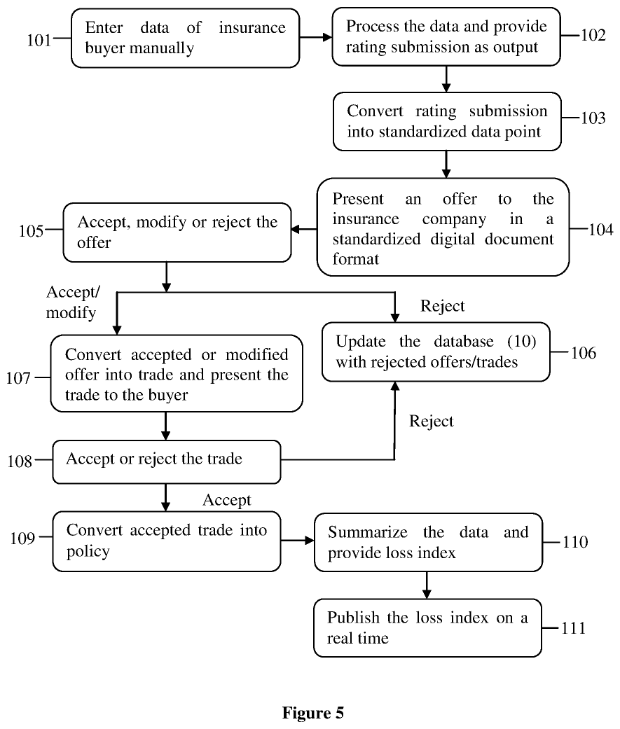

Referring now to FIG. 5, in another aspect, a method for providing an automatic rating and electronic trading of insurance risks in accordance with the present invention is shown. Specifically, the method is described herein below in conjunction with the system (100) of FIG. 2.

In a first step (101), the method involves entering data of an insurance buyer by a broker in the user interface (20). The data is entered manually by the broker.

At step (102), the method involves processing the data entered by the broker and providing a rating submission as an output. The data entered by the broker is fed into the premium computation algorithm for processing the data. A standardized output in the form of submission is prepared but premium is not computed by the premium computation algorithm in this step.

At step (103), the method involves converting the rating submission into a standardized data point. The submission workspace (30) collates data entered by the brokers and prepares an offer to be presented to the insurance companies. Particularly, the premium submission with other client details is combined to create a trade or offer to be presented by the brokers to the insurance companies.

At step (104), the method involves presenting the offer to the insurance company in a standardized digital document format.

At step (105), the method involves deciding to accept, modify or reject the offer by the insurance/reinsurance companies and providing a summarized data of the accepted offers. The insurance company modifies or accepts or rejects the offer made by the broker. The rejected offers are saved into the database (10) for future analysis at step (106).

At step (107), the method involves converting the accepted or modified offer into a trade and presenting the trade to the buyer through the broker. Once the insurance company accepts the offer, any modifications are taken into consideration and premium is computed. The submission/offer from the broker are converted into quotation from the insurance company.

At step (108), the method involves deciding to accept or reject the trade by the buyer. The rejected trades are saved into the database (10) for future analysis. If the trade is accepted, the trade is converted into a policy at step (109).

At step (110), the method involves summarizing the data and providing a loss index as a public data set. Based on the action by the insurance buyer, the premium computation algorithm either update the loss index with weight values for live insurance contract or update the database (10) of rejected offers for future reference. In a final step (111), the method involves publishing the loss index on a real time basis thereby helping various participants for decision support. The major application of index values is intended to be the basis for insurance derivatives.

In accordance with the present invention, the system (100) and the method simplify the insurance buying and claims reporting procedure through standardization of data points, transparent price discovery mechanism, defined timelines for each insurance process till buying of insurance and defined publicly accessible claims reporting mechanism. As the basis of insurance business is data, the system (100) and the method standardize the data points thus allowing seamless exchange of information between various participants of the insurance market. The system (100) and the method generate the loss index through the accumulated risk data and provide dynamic risk assessment based on past pool of risks.

### Advantages of the Invention

1. The system (100) and the method facilitate automation of premium computation leading to robust decision support system for underwriters.
2. The system (100) and the method save cost to insurance players due to reduced processing time and higher volume of trades leading to profitable operations and lower premiums for the buyers in the long run.
3. The system (100) and the method facilitate standardization and automation of the routine underwriting processes thereby enabling insurance companies to carry out faster decision making.
4. The system (100) and the method provide validated loss index that is useful as an underlying asset for insurance linked derivative securities.
5. The system (100) and the method facilitate exclusivity to insurance intermediaries leading to transparency in the dealings and eradication of arbitrary margins charged by the brokers.
6. The system (100) and the method facilitate the standardization of the insurance information resulting in simplification of processes and output to the clients.
7. The system (100) and the method allow effective real time monitoring of the insurance regulations by regulators.
8. The system (100) and the method facilitate transfer of risks through insurance linked securities thereby helping to exponential growth of the insurance market.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the scope of the present invention.

1. A system for providing an automatic rating and electronic trading of insurance risks, the system comprising:
a database adapted to store data for all clients, brokers and insurance companies;
a middleware operably connected to the database, the middleware having a premium computation algorithm embedded therein;
a user interface operably connected to the database, the user interface capable of receiving the data feed through a manual entry from the brokers;
a submission workspace capable of collating the data entered by the brokers, receiving premium amounts and preparing an offer to be presented to the insurance companies;
an application interface for presenting the offer with a suggested premium to the insurance companies; and
a trading interface operably connected to the application interface for providing a decision support for the insurance companies and the application interface for presenting a trade to the buyer for a final decision.

2. The system as claimed in claim 1, wherein the premium computation algorithm is adapted to update a loss index with weight values for live insurance contract and to update the database of rejected offers for future reference.

3. A method for providing an automatic rating and electronic trading of insurance risks, the method comprising the steps of:
entering data of an insurance buyer by a broker in a user interface, wherein the data is entered manually;
processing the data entered by the broker by a premium computation algorithm and providing a rating submission as an output, wherein the premium computation algorithm is embedded in a middleware;
converting the rating submission into a standardized data point, wherein a submission workspace collates the data entered by the broker and prepares an offer to be presented to the insurance companies;
presenting the offer to the insurance company in a standardized digital document format;
deciding to accept, modify or reject the offer by the insurance/reinsurance companies and providing a summarized data of the accepted offers;
converting the accepted or modified offer into a trade and presenting the trade to the buyer through the broker;
deciding to accept or reject the trade by the buyer;
converting the accepted trade into a policy;
summarizing the data and providing a loss index as a public data set; and
publishing the loss index on a real time basis.

4. The method as claimed in claim 3, wherein the rejected offers and the rejected trades are saved into a database for future analysis.

5. The method as claimed in claim 3, wherein the premium computation algorithm is adapted to update the loss index with weight values for live insurance contract and to update the database of rejected offers for future reference.
